(19) United States
(12) Patent Application Publication
(10) Pub. No.: US 2013/0088891 A1
(43) Pub. Date: Apr. 11, 2013

(54) LIGHT SOURCE DEVICE, DISPLAY UNIT, AND ELECTRONIC APPARATUS

(71) Applicant: Sony Corporation, Tokyo (JP)

(72) Inventor: Masaru Minami, Kanagawa (JP)

(73) Assignee: Sony Corporation, Tokyo (JP)

(21) Appl. No.: 13/667,900

(22) Filed: Nov. 2, 2012

(30) Foreign Application Priority Data
Oct. 11, 2011 (JP) 2011-246772

(51) Int. Cl. F21V 8/00

(52) U.S. Cl. 362/611

(57) ABSTRACT

A display unit includes: a display section including a plurality of pixels; and a light source device disposed to face the display section and to emit light for image display toward the display section, the light source device including a first light source emitting first illumination light, and a light guide plate including a plurality of scattering region groups that allow the first illumination light entering through a side surface of the light guide plate to be scattered and then to exit from the light guide plate. Each scattering region group includes a plurality of scattering regions distributed as a whole in a first oblique direction with respect to a vertical direction and in a plane parallel to a plane where the pixels are arranged. One or more of the scattering regions extend in a second oblique direction opposite to the first oblique direction with respect to the vertical direction.

### BACKGROUND

The present disclosure relates to a light source device and a display unit capable of achieving stereoscopic vision by a parallax barrier system, and an electronic apparatus.

As one of stereoscopic display systems capable of achieving stereoscopic vision with naked eyes without wearing special glasses, a parallax barrier system stereoscopic display unit is known. In the stereoscopic display unit, a parallax barrier is disposed to face a front side (a display plane side) of a two-dimensional display panel. In a typical configuration of the parallax barrier, shielding sections shielding display image light from the two-dimensional display panel and stripe-shaped opening sections (slit sections) allowing the display image light to pass therethrough are alternately arranged in a horizontal direction.

In the parallax barrier system, parallax images for stereoscopic vision (a right-eye parallax image and a left-eye parallax image in the case of two perspectives) which are spatially separated from one another are displayed on the two-dimensional display panel, and the parallax images are separated by parallax in the horizontal direction by the parallax barrier to achieve stereoscopic vision. When a slit width or the like in the parallax barrier is appropriately determined, in the case where a viewer watches the stereoscopic display unit from a predetermined position and a predetermined direction, light rays from different parallax images enter respective right and left eyes of the viewer through the slit sections.

It is to be noted that, in the case where, for example, a transmissive liquid crystal display panel is used as the two-dimensional display panel, a parallax barrier may be disposed behind the two-dimensional display panel (refer to FIG. 10 in Japanese Patent No. 3565391 and FIG. 3 in Japanese Unexamined Patent Application Publication No. 2007-187823). In this case, the parallax barrier is disposed between the transmissive liquid crystal display panel and a backlight.

### SUMMARY

In parallax barrier system stereoscopic display units, a component exclusive for three-dimensional display, i.e., a parallax barrier is necessary; therefore, more components and a larger space for the components are necessary, compared to a typical display unit for two-dimensional display. Moreover, display units capable of arbitrarily performing one of two-dimensional display and three-dimensional display by switching are in demand. In this case, it is necessary for the display units to perform both two-dimensional display and three-dimensional display with favorable quality. To do so, it is necessary to obtain illumination light with an appropriate luminance distribution for both two-dimensional display and three-dimensional display.

It is desirable to provide a light source device and a display unit capable of achieving a function equivalent to a parallax barrier with use of a light guide plate and obtaining illumination light with an appropriate luminance distribution, and an electronic apparatus.

According to an embodiment of the disclosure, there is provided a light source device including: a first light source emitting first illumination light; and a light guide plate disposed to face a display section including a plurality of pixel arranged, the light guide plate including a plurality of scattering region groups that allow the first illumination light entering through a side surface of the light guide plate to be scattered and then to exit from the light guide plate, in which each of the scattering region groups includes a plurality of scattering regions distributed as a whole in a first oblique direction with respect to a vertical direction and in a plane parallel to a plane where the pixels are arranged, and one or more of the plurality of scattering regions extend in a second oblique direction opposite to the first oblique direction with respect to the vertical direction.

According to an embodiment of the disclosure, there is provided a display unit including: a display section including a plurality of pixels arranged; and a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate, in which each of the scattering region groups includes a plurality of scattering regions distributed as a whole in a first oblique direction with respect to a vertical direction and in a plane parallel to a plane where the pixels are arranged, and one or more of the plurality of scattering regions extend in a second oblique direction opposite to the first oblique direction with respect to the vertical direction.

According to an embodiment of the disclosure, there is provided an electronic apparatus including a display unit, the display unit including: a display section including a plurality of pixels arranged; and a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate, in which each of the scattering region groups includes a plurality of scattering regions distributed as a whole in a first oblique direction with respect to a vertical direction and in a plane parallel to a plane where the pixels are arranged, and one or more of the plurality of scattering regions extend in a second oblique direction opposite to the first oblique direction with respect to the vertical direction.

In the light source device, the display unit, and the electronic apparatus according to the embodiments of the disclosure, the first illumination light from the first light source is scattered by the scattering regions to exit from the light guide plate. Therefore, the light guide plate has a function as a parallax barrier with respect to the first illumination light. In other words, the light guide plate equivalently functions as a parallax barrier with the scattering regions as opening sections (slit sections). Therefore, three-dimensional display is possible. Moreover, for example, two-dimensional display is possible by emitting illumination light from a back side of the scattering regions. In this case, when one or more of the plurality of scattering regions extend in the second oblique direction opposite to the first oblique direction with respect to the vertical direction, a luminance distribution in two-dimensional display is improved.

In the light source device, the display unit, and the electronic apparatus according to the embodiments of the disclosure, the light guide plate has the plurality of scattering regions allowing the first illumination light to be scattered; therefore, the light guide plate equivalently has a function as a parallax barrier with respect to the first illumination light. Moreover, as one or more of the plurality of scattering regions extend in the second oblique direction opposite to the first oblique direction with respect to the vertical direction, a luminance distribution in a case where illumination light is emitted from a back side of the scattering regions is improved. Thus, illumination light with an appropriate luminance distribution is obtainable.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a sectional view illustrating a configuration example of a display unit according to a first embodiment of the disclosure with a state of emission of light rays from a light source device in the case where only a first light source is maintained in an ON (turned-on) state.

FIG. 2 is a sectional view illustrating a configuration example of the display unit illustrated in FIG. 1 with a state of emission of light rays from the light source device in the case where only a second light source is maintained in the ON (turned-on) state.

FIGS. 3A and 3B are a sectional view and an explanatory diagram, respectively, where FIG. 3A illustrates a state of emission of light rays from the light source device in the case where only the second light source is maintained in the ON (turned-on) state in consideration of a decline in luminance in scattering regions, and FIG. 3B illustrates a luminance distribution in the case where only the second light source is maintained in the ON state.

FIG. 4 is a plan view illustrating an example of a pixel configuration of a display section.

FIGS. 5A and 5B are a sectional view and an explanatory diagram, respectively, where FIG. 5A illustrates a first configuration example of a surface of a light guide plate in the display unit illustrated in FIG. 1, and FIG. 5B schematically illustrates scattering and reflection states of light rays on the surface of the light guide plate illustrated in FIG. 5A.

FIGS. 6A and 6B are a sectional view and an explanatory diagram, respectively, where FIG. 6A illustrates a second configuration example of the surface of the light guide plate in the display unit illustrated in FIG. 1, and FIG. 6B schematically illustrates scattering and reflection states of light rays on the surface of the light guide plate illustrated in FIG. 6A.

FIGS. 7A and 7B are a sectional view and an explanatory diagram, respectively, where FIG. 7A illustrates a third configuration example of the surface of the light guide plate in the display unit illustrated in FIG. 1, and FIG. 7B schematically illustrates scattering and reflection states of light rays on the surface of the light guide plate illustrated in FIG. 7A.

FIG. 8 is a plan view illustrating a first comparative example of an arrangement pattern of scattering regions.

FIG. 9 is an explanatory diagram illustrating the first comparative example of the arrangement pattern of the scattering regions.

FIG. 10 is a plan view illustrating a second comparative example of an arrangement pattern of the scattering regions.

FIG. 11 is an explanatory diagram illustrating the second comparative example of the arrangement pattern of the scattering regions.

FIG. 12 is a plan view illustrating an example of an arrangement pattern of scattering regions.

FIG. 13 is an explanatory diagram illustrating the example of the arrangement pattern of the scattering regions.

FIG. 14 is a plan view illustrating a first modification of the arrangement pattern of the scattering regions.

FIG. 15 is an explanatory diagram illustrating the first modification of the arrangement pattern of the scattering regions.

FIG. 16 is a plan view illustrating a second modification of the arrangement pattern of the scattering regions.

FIG. 17 is an explanatory diagram illustrating the second modification of the arrangement pattern of the scattering regions.

FIG. 18 is a plan view illustrating a third modification of the arrangement pattern of the scattering regions.

FIG. 19 is an explanatory diagram illustrating the third modification of the arrangement pattern of the scattering regions.

FIG. 20 is a plan view illustrating a fourth modification of the arrangement pattern of the scattering regions.

FIG. 21 is an explanatory diagram illustrating the fourth modification of the arrangement pattern of the scattering regions.

FIG. 22 is a plan view illustrating a fifth modification of the arrangement pattern of the scattering regions.

FIG. 23 is an explanatory diagram illustrating the fifth modification of the arrangement pattern of the scattering regions.

FIG. 24 is an explanatory diagram illustrating the fifth modification of the arrangement pattern of the scattering regions.

FIG. 25 is a plan view illustrating a sixth modification of the arrangement pattern of the scattering regions.

FIG. 26 is an explanatory diagram illustrating the sixth modification of the arrangement pattern of the scattering regions.

FIGS. 27A and 27B are sectional views illustrating a configuration example of a display unit according to a third embodiment with states of emission of light rays from a light source device in three-dimensional display and in two-dimensional display, respectively.

FIGS. 28A and 28B are sectional views illustrating a configuration example of a display unit according to a fourth embodiment with states of emission of light rays from a light source device in three-dimensional display and in two-dimensional display, respectively.

FIGS. 29A and 29B are sectional views illustrating a configuration example of a display unit according to a fifth embodiment with states of emission of light rays from a light source device in three-dimensional display and in two-dimensional display, respectively.

FIG. 30 is an appearance diagram illustrating an example of an electronic apparatus.

### DETAILED DESCRIPTION

Preferred embodiments of the disclosure will be described in detail below referring to the accompanying drawings. It is to be noted that description will be given in the following order.

1. First Embodiment

An example of a display unit using a first light source and a second light source

An example of a display unit in which scattering regions are located on a second internal reflection plane

2. Second Embodiment

First to sixth modifications of the first embodiment

3. Third Embodiment

An example of a display unit using a first light source and a second light source

An example of the display unit in which scattering regions are located on a first internal reflection plane

4. Fourth Embodiment

An example of a display unit using a first light source and an electronic paper

5. Fifth Embodiment

An example of a display unit using a first light source and a polymer diffuser plate

6. Other Embodiments

A configuration example of an electronic apparatus, and the like

### 1. First Embodiment

[Entire Configuration of Display Unit]

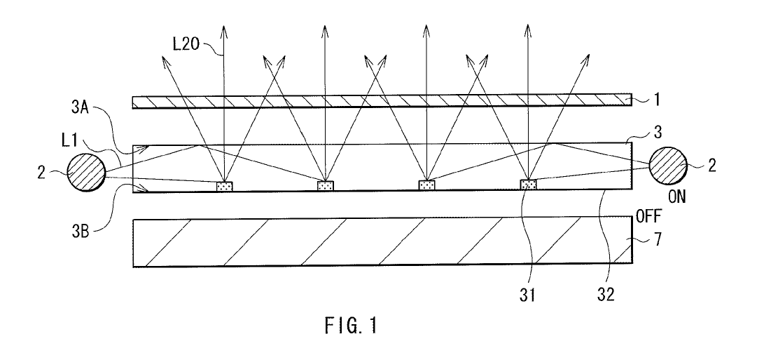

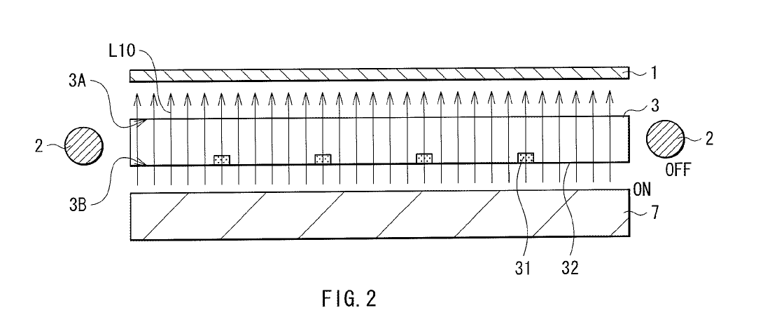

FIGS. 1 and 2 illustrate a configuration example of a display unit according to a first embodiment of the disclosure. The display unit includes a display section 1 which displays an image and a light source device which is disposed on a back side of the display section 1 and emits light for image display toward the display section 1. The light source device includes a first light source 2 (a 2D/3D-display light source), a light guide plate 3, and a second light source 7 (a 2D-display light source). The light guide plate 3 has a first internal reflection plane 3A facing the display section 1 and a second internal reflection plane 3B facing the second light source 7. It is to be noted that the display unit includes a control circuit for the display section 1 or the like which is necessary for display; however, the control circuit or the like has a configuration similar to that of a typical control circuit for display or the like, and will not be described here. Moreover, the light source device includes a control circuit (not illustrated) controls ON (turned-on) and OFF (turned-off) states of the first light source 2 and the second light source 7.

It is to be noted that, in the embodiment, a first direction (a vertical direction) in a display plane (a plane where pixels are arranged) of the display section 1 or a plane parallel to the second internal reflection plane 3B of the light guide plate 3 is referred to as a Y direction, and a second direction (a horizontal direction) orthogonal to the first direction is referred to as an X direction. Moreover, a direction (a thickness direction) orthogonal to the Y direction and the X direction is referred to as a Z direction.

The display unit is capable of arbitrarily and selectively performing switching between a two-dimensional (2D) display mode on an entire screen and a three-dimensional (3D) display mode on the entire screen. Switching between the two-dimensional display mode and the three-dimensional display mode is performed by switching control of image data which is to be displayed on the display section 1 and ON/OFF switching control of the first light source 2 and the second light source 7. FIG. 1 schematically illustrates a state of emission of light rays from the light source device in the case where only the first light source 2 is maintained in an ON (turned-on) state, and corresponds to the three-dimensional display mode. FIG. 2 schematically illustrates a state of emission of light rays from the light source device in the case where only the second light source 7 is maintained in an ON (turned-on) state, and corresponds to the two-dimensional display mode.

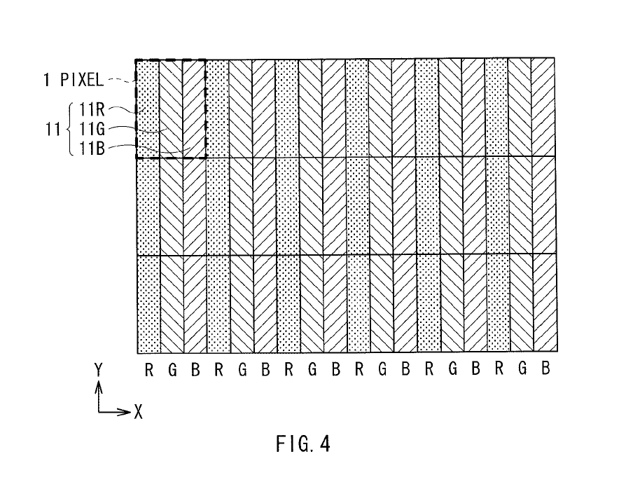

The display section 1 is configured with use of a transmissive two-dimensional display panel, for example, a transmissive liquid crystal display panel, and includes a plurality of pixels 11 configured of, for example, R (red) pixels 11R, G (green) pixels 11G, and B (blue) pixels 11B, and the plurality of pixels 11 are arranged in a matrix form as illustrated in FIG. 4. The display section 1 displays a two-dimensional image through modulating light of each color from the light source device from one pixel 11 to another based on image data. The display section 1 arbitrarily and selectively switching images to be displayed between a plurality of perspective images based on three-dimensional image data and an image based on two-dimensional image data. It is to be noted that the three-dimensional image data is, for example, data including a plurality of perspective images corresponding to a plurality of view angle directions in three-dimensional display. For example, in the case where binocular three-dimensional display is performed, the three-dimensional image data is data including perspective images for right-eye display and left-eye display. In the case where display is performed in the three-dimensional display mode, for example, a composite image including a plurality of stripe-shaped perspective images in one screen is produced and displayed.

The first light source 2 is configured with use of, for example, a fluorescent lamp such as a CCFL (Cold Cathode Fluorescent Lamp), or an LED (Light Emitting Diode). The first light source 2 emits first illumination light L1 (refer to FIG. 1) from a side surface of the light guide plate 3 into an interior thereof. One or more first light sources 2 are disposed on one or more side surfaces of the light guide plate 3. For example, in the case where the light guide plate 3 has a rectangular planar shape, the light guide plate 3 has four side surfaces, and it is only necessary to arrange one or more first light sources 2 on one or more of the four side surfaces. FIG. 1 illustrates a configuration example in which the first light source 2 is disposed on each of two side surfaces facing each other of the light guide plate 3. The first light source 2 is ON (turned-on)/OFF (not turned-on) controlled in response to switching between the two-dimensional display mode and the three-dimensional display mode. More specifically, in the case where the display section 1 displays an image based on the three-dimensional image data (in the case of the three-dimensional display mode), the first light source 2 is controlled to be turned on, and in the case where the display section 1 displays an image based on the two-dimensional image data (in the case of the two-dimensional display mode), the first light source 2 is controlled to be either turned off or turned on.

The second light source 7 is disposed to face the second internal reflection plane 3B of the light guide plate 3. The second light source 7 emits second illumination light L10 toward the light guide plate 3 from a direction different from the direction where the first light source 2 emits the first illumination light L1. More specifically, the second light source 7 emits the second illumination light L10 from an external side (the back side of the light guide plate 3) toward the second internal reflection plane 3B (refer to FIG. 2). The second light source 7 may be a planar light source emitting light with uniform in-plane luminance, and the configuration thereof is not specifically limited, and the second light source 7 may be configured with use of a commercially available planar backlight. For example, a configuration using a light-emitting body such as a CCFL or an LED and a light-scattering plate for equalizing in-plane luminance, or the like is considered. The second light source 7 is ON (turned-on)/OFF (turned-off) controlled in response to switching between the two-dimensional display mode and the three-dimensional display mode. More specifically, in the case where the display section 1 displays an image based on the three-dimensional image data (in the case of the three-dimensional display mode), the second light source 7 is controlled to be turned off, and in the case where the display section 1 displays an image based on the two-dimensional image data (in the case of the two-dimensional display mode), the second light source 7 is controlled to be turned on.

The light guide plate 3 is configured of a transparent plastic plate of, for example, an acrylic resin. All surfaces except for the second internal reflection plane 3B of the light guide plate 3 are entirely transparent. For example, in the case where the light guide plate 3 has a rectangular planar shape, the first internal reflection plane 3A and four side surfaces are entirely transparent.

The entire first internal reflection plane 3A is mirror-finished, and allows light rays incident at an incident angle satisfying a total-reflection condition to be reflected, in a manner of total-internal-reflection, in the interior of the light guide plate 3 and allows light rays out of the total-reflection condition to exit therefrom.

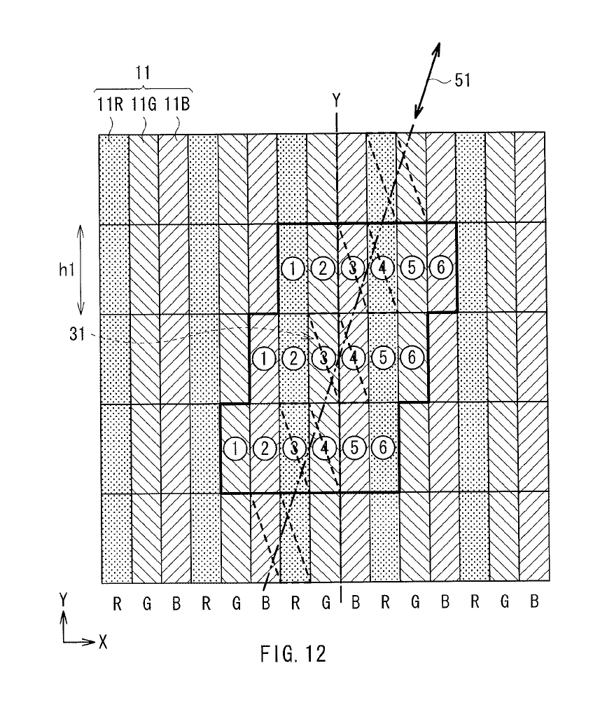

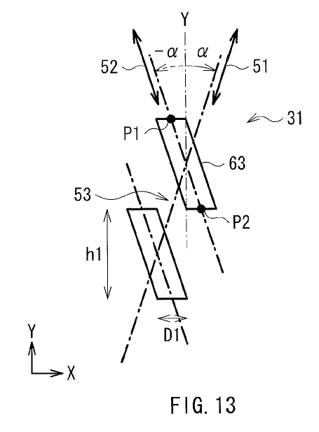

The second internal reflection plane 3B has scattering regions 31 and a total-reflection region 32. As will be described later, each scattering region 31 is formed by laser processing, sandblast processing, or coating on a surface of the light guide plate 3, or bonding a sheet-like light-scattering member on the surface of the light guide plate 3. On the second internal reflection plane 3B, in the three-dimensional display mode, the scattering regions 31 and the total-reflection region 32 function as opening sections (slit sections) and a shielding section, respectively, of a parallax barrier for the first illumination light L1 from the first light source 2. On the second internal reflection plane 3B, the scattering regions 31 and the total-reflection region 32 are arranged in a pattern forming a configuration corresponding to a parallax barrier. In other words, the total-reflection region 32 is arranged in a pattern corresponding to a shielding section in the parallax barrier, and the scattering regions 31 each are arranged in a pattern corresponding to an opening section in the parallax barrier. It is to be noted that a specific arrangement pattern of the scattering regions 31 is, for example, as illustrated in FIGS. 12 and 13, and will be described in detail later.

The first internal reflection plane 3A and the total-reflection region 32 of the second internal reflection plane 3B reflect light rays incident at an incident angle θ1 satisfying a total-reflection condition in a manner of total-internal-reflection (reflect light rays incident at the incident angle θ1 larger than a predetermined critical angle α in a manner of total-internal-reflection). Therefore, the first illumination light L1 incident from the first light source 2 at the incident angle θ1 satisfying the total-reflection condition is guided to a side surface direction by internal total reflection between the first internal reflection plane 3A and the total-reflection region 32 of the second internal reflection plane 3B. Moreover, as illustrated in FIG. 2, the total-reflection region 32 allows the second illumination light L10 from the second light source 7 to pass therethrough and to travel, as a light ray out of the total-reflection condition, toward the first internal reflection plane 3A.

It is to be noted that the critical angle α is represented as follows, where the refractive index of the light guide plate 3 is n1, and the refractive index of a medium (an air layer) outside the light guide plate 3 is n0 (<n1). The angles α and θ1 are angles with respect to a normal to a surface of the light guide plate. The incident angle θ1 satisfying the total-reflection condition is θ1>α.

sin α=n0/n1

As illustrated in FIG. 1, the scattering regions 31 scatter and reflect the first illumination light L1 from the first light source 2 and allows a part or a whole of the first illumination light L1 to travel, as a light ray (a scattering light ray L20) out of the total-reflection condition, toward the first internal reflection plane 3A.

It is to be noted that, in the display unit illustrated in FIG. 1, to spatially separate a plurality of perspective images displayed on the display section 1, it is necessary to dispose a pixel section of the display section 1 and the scattering regions 31 of the light guide plate 3 to face each other with a predetermined distance in between. In FIG. 1, the display section 1 and the light guide plate 3 are disposed with air in between; however, to keep the predetermined distance between the display section 1 and the light guide plate 3, a spacer may be disposed between the display section 1 and the light guide plate 3. In this case, the spacer may be made of a colorless and transparent material with less scattering, and, for example, PMMA may be used. The spacer may be disposed to cover an entire back surface of the display section 1 and an entire surface of the light guide plate 3, or may be disposed in a minimum region necessary to keep the predetermined distance. Moreover, an entire thickness of the light guide plate 3 may be increased to remove air between the display section 1 and the light guide plate 3.

### SPECIFIC CONFIGURATION EXAMPLE OF SCATTERING REGION 31

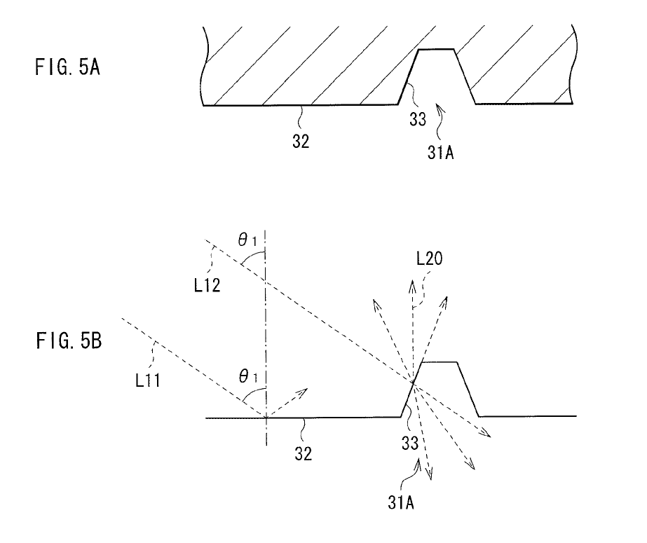

FIG. 5A illustrates a first configuration example of the second internal reflection plane 3B in the light guide plate 3. FIG. 5B schematically illustrates reflection and scattering states of light rays on the second internal reflection plane 3B in the first configuration example illustrated in FIG. 5A. In the first configuration example, the scattering region 31 is a recessed scattering region 31A with respect to the total-reflection region 32. Such a recessed scattering region 31A is formed by, for example, sandblast processing or laser processing. For example, a surface of the light guide plate 3 is minor-finished, and then a portion corresponding to the scattering region 31A is subjected to laser processing to form the scattering region 31A. In the first configuration example, first illumination light L11 from the first light source 2 incident at the incident angle θ1 satisfying the total-reflection condition is reflected in a manner of total-internal-reflection by the total-reflection region 32 of the second internal reflection plane 3B. On the other hand, even if light enters the recessed scattering region 31A at the same incident angle θ1 as in the case where light enters the total-reflection region 32, some light rays of first illumination light L12 having entered the recessed scattering region 31A do not satisfy the total-reflection condition on a side surface portion 33 of a recessed shape, and are scattered and pass through the side surface portion 33, and other light rays are scattered and reflected by the side surface portion 33. As illustrated in FIG. 1, some or all of scattered and reflected light rays (scattering light rays L20) travel, as light rays out of the total-reflection condition, toward the first internal reflection plane 3A.

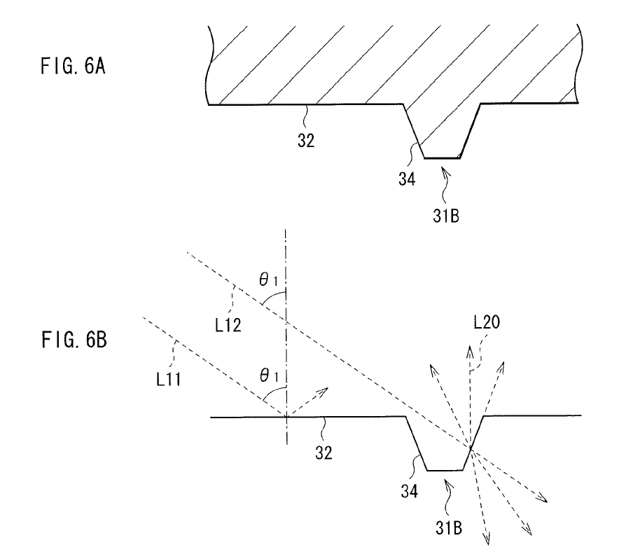

FIG. 6A illustrates a second configuration example of the second internal reflection plane 3B of the light guide plate 3. FIG. 6B schematically illustrates reflection and scattering states of light rays on the second internal reflection plane 3B in the second configuration example in FIG. 6A. In the second configuration example, the scattering region 31 is a projected scattering region 31B with respect to the total-reflection region 32. Such a projected scattering region 31B is formed, for example, through molding a surface of the light guide plate 3 with a die. In this case, a portion corresponding to the total-reflection region 32 is minor-finished by a surface of the die. In the second configuration example, the first illumination light L11 from the first light source 2 incident at the incident angle θ1 satisfying the total-reflection condition is reflected in a manner of total-internal-reflection by the total-reflection region 32 of the second internal reflection plane 3B. On the other hand, even if light enters the projected scattering region 31B at the same incident angle θ1 as in the case where light enters the total-reflection region 32, some light rays of the first illumination light L12 having entered the projected scattering region 31B do not satisfy the total-reflection condition on a side surface portion 34 of a projected shape, and are scattered and pass through the side surface portion 34, and other light rays are scattered and reflected by the side surface portion 34. As illustrated in FIG. 1, some or all of scattered and reflected light rays (scattering light rays L20) travel, as light rays out of the total-reflection condition, toward the first internal reflection plane 3A.

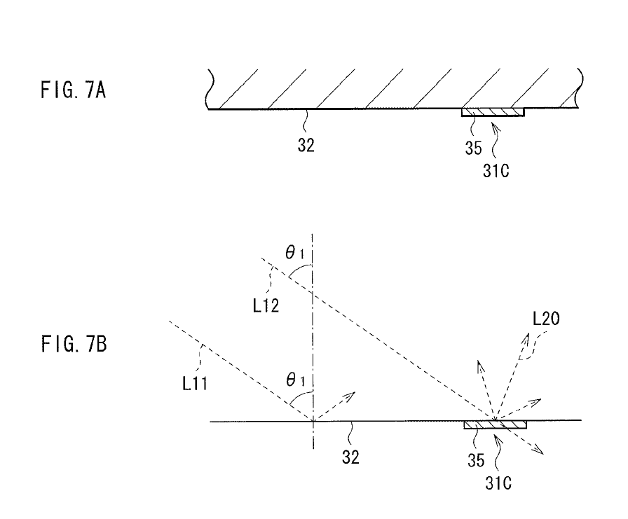

FIG. 7A illustrates a third configuration example of the second internal reflection plane 3B of the light guide plate 3. FIG. 7B schematically illustrates the reflection and scattering states of light rays on the second internal reflection plane 3B in the third configuration example illustrated in FIG. 7A. In the configuration examples in FIGS. 5A and 6A, the surface of the light guide plate 3 is processed into a geometry different from that of the total-reflection region 32 to form the scattering region 31. On the other hand, in a scattering region 31C in the configuration example in FIG. 7A, instead of processing the surface of the light guide plate 3, a light-scattering member 35 made of a material different from that of the light guide plate 3 is disposed on a surface, corresponding to the second internal reflection plane 3B, of the light guide plate 3. In this case, a white paint (for example, barium sulfate) as the light-scattering member 35 is patterned on the surface of the light guide plate 3 by screen printing to form the scattering region 31C. In the third configuration example, the first illumination light L11 from the first light source 2 incident at the incident angle θ1 satisfying the total-reflection condition is reflected by the total-reflection region 32 of the second internal reflection plane 3B in a manner of total-internal-reflection. On the other hand, even if light enters the scattering region 31C where the light-scattering member 35 is disposed at the same incident angle θ1 as in the case where light enters the total-reflection region 32, a part of the first illumination light L12 having entered the scattering region 31C is scattered and passes through the scattering region 31C by the light-scattering member 35, and other light is scattered and reflected by the light-scattering member 35. Some or all of light rays scattered and reflected travel, as light rays out of the total-reflection condition, toward the first internal reflection plane 3A.

### [Basic Operation of Display Unit]

In the case where the display unit performs display in the three-dimensional display mode, the display section 1 displays an image based on the three-dimensional image data, and ON (turned-on)/OFF (turned-off) control of the first light source 2 and the second light source 7 is performed for three-dimensional display. More specifically, as illustrated in FIG. 1, the first light source 2 is controlled to be in the ON (turned-on) state, and the second light source 7 is controlled to be in the OFF (turned-off) state. In this state, the first illumination light L1 from the first light source 2 is reflected repeatedly in a manner of total-internal-reflection between the first internal reflection plane 3A and the total-reflection region 32 of the second internal reflection plane 3B in the light guide plate 3 to be guided from a side surface where the first light source 2 is disposed to the other side surface facing the side surface and then to be emitted from the other side surface. On the other hand, a part of the first illumination light L1 from the first light source 2 is scattered and reflected by the scattering regions 31 of the light guide plate 3 to pass through the first internal reflection plane 3A of the light guide plate 3 and exit from the light guide plate 3. Thus, the light guide plate 3 has a function as a parallax barrier. In other words, for the first illumination light L1 from the first light source 2, the light guide plate 3 equivalently functions as a parallax barrier with the scattering regions 31 as opening sections (slit sections) and the total-reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode, the display section 1 displays an image based on the two-dimensional image data, and the first light source 2 and the second light source 7 are ON (turned-on)/OFF (turned-off) controlled for two-dimensional display. More specifically, for example, as illustrated in FIG. 2, the first light source 2 is controlled to be in the OFF (turned-off) state, and the second light source 7 is controlled to be in the ON (turned-on) state. In this case, the second illumination light L10 from the second light source 7 passes through the total-reflection region 32 of the second internal reflection plane 3B to exit as a light ray out of the total-reflection condition from substantially the entire first internal reflection plane 3A of the light guide plate 3. In other words, the light guide plate 3 functions as a planar light source similar to a typical backlight. Therefore, two-dimensional display by a backlight system in which a typical backlight is equivalently disposed on the back side of the display section 1 is performed.

It is to be noted that, when only the second light source 7 is turned on, the second illumination light L10 exits from substantially the entire surface of the light guide plate 3; however, if necessary, the first light source 2 may be turned on. For example, in the case where there is a difference in a luminance distribution between portions corresponding to the scattering regions 31 and a portion corresponding to the total-reflection region 32 when only the second light source 7 is turned on, the lighting state of the first light source 2 is appropriately adjusted (ON/OFF control or the lighting amount of the first light source 2 is adjusted) to allow an entire luminance distribution to be optimized. However, for example, in the case where luminance is sufficiently corrected in the display section 1 when two-dimensional display is performed, it is only necessary to turn on the second light source 7 only.

### SPECIFIC EXAMPLE OF ASSIGNMENT PATTERN OF PERSPECTIVE IMAGES AND ARRANGEMENT PATTERN OF SCATTERING REGIONS 31

When the display unit performs display in the three-dimensional display mode, a plurality of perspective images assigned to respective pixels 11 in a predetermined assignment pattern are displayed on the display section 1. The plurality of scattering regions 31 in the light guide plate 3 are arranged in a predetermined arrangement pattern corresponding to the predetermined assignment pattern.

### COMPARATIVE EXAMPLE

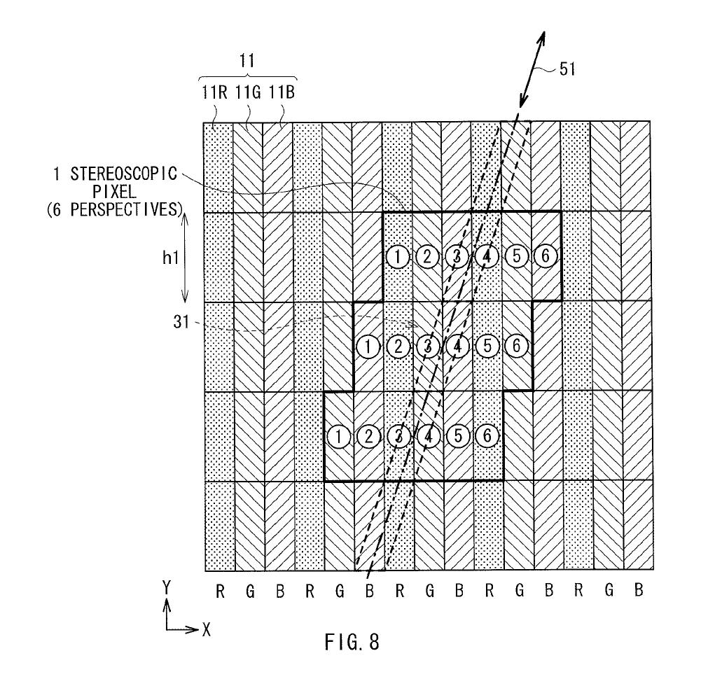

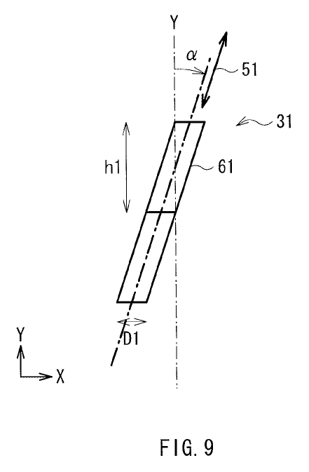

First, an arrangement pattern in a comparative example will be described below. FIGS. 8 and 9 illustrate a first comparative example of the arrangement pattern of the scattering regions 31. In FIG. 8, circled FIGS. 1 to 6 assigned to respective color pixels 11R, 11G, and 11B indicate pixel numbers (perspective numbers) corresponding to the number of perspectives for display. In FIG. 8, first to sixth perspective images are assigned to one unit pixel (one stereoscopic pixel) for three-dimensional display. A combination of three respective color pixels 11R, 11G, and 11B continuously arranged in an oblique direction is a unit pixel for one perspective.

In the first comparative example, as illustrated in FIG. 9, a plurality of scattering regions 61 obliquely arranged to extend in a first oblique direction 51 with respect to the vertical direction (the Y direction) are continuously distributed to form one scattering region group. The one scattering region group is distributed to be astride pixels in a central region of one stereoscopic pixel when viewed from a direction perpendicular to an arrangement plane of the pixels 11, i.e., a pixel for the third perspective and a pixel for the fourth perspective in an example in FIG. 8. A height (vertical length) h1 of the scattering region 61 is substantially equal to a height of each of the respective color pixels 11R, 11G, and 11B. A width (horizontal length) D1 of the scattering region 61 is substantially equal to the width of each of the respective color pixels 11R, 11G, and 11B. It is to be noted that, in FIG. 8, only one scattering region group is illustrated as a representative; however, a plurality of scattering region groups are distributed as a whole in the horizontal direction. Therefore, a combination of all of the scattering region groups has a configuration equivalent to that of a parallax barrier with an obliquely striped barrier pattern.

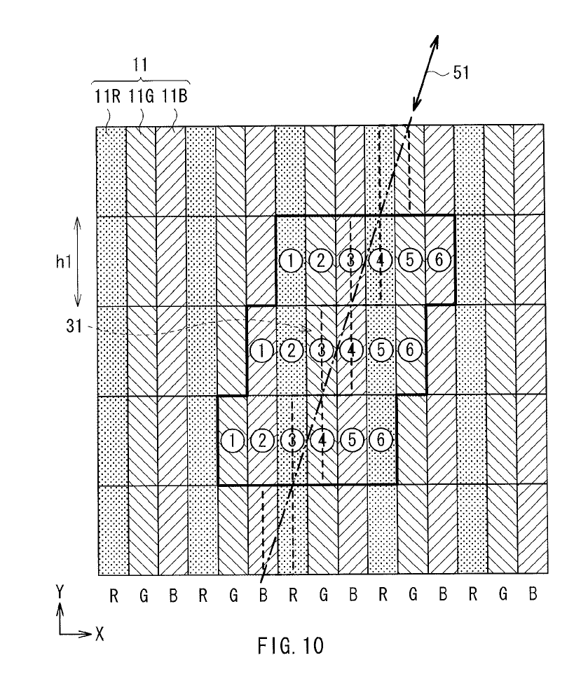

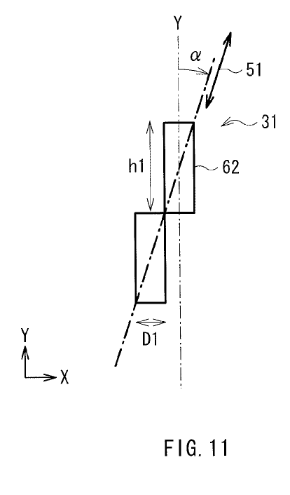

FIGS. 10 and 11 illustrate a second comparative example of the arrangement pattern of the scattering regions 31. An assignment pattern of the perspective images illustrated in FIG. 10 are similar to that in FIG. 8. In the second comparative example, as illustrated in FIG. 11, a plurality of rectangular scattering regions 62 extending in the vertical direction (the Y direction) are continuously distributed in the first oblique direction 51 to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 10. The height (vertical length) h1 of the scattering region 62 is substantially equal to the height of each of the respective color pixels 11R, 11G, and 11B. The width (horizontal length) D1 of the scattering region 62 is substantially equal to the width of each of the respective color pixels 11R, 11G, and 11B. It is to be noted that, in FIG. 10, only one scattering region group is illustrated as a representative; however, a plurality of scattering region groups are distributed as a whole in the horizontal direction. Therefore, a combination of all of the scattering region groups has a configuration equivalent to that of a parallax barrier with a stepwise barrier pattern. (Disadvantages of configurations of comparative examples)

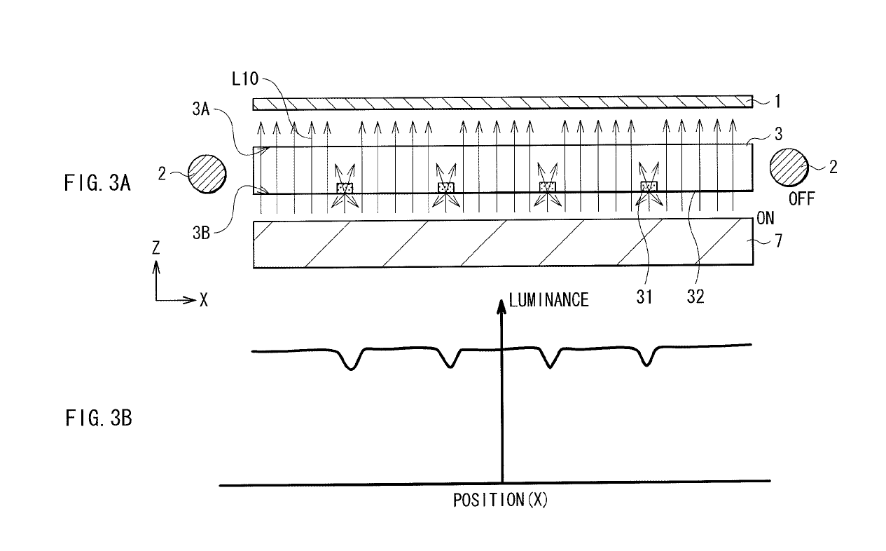

FIG. 2 illustrates an ideal state of emission of light rays in the case where only the second light source 7 is maintained in the ON (turned-on) state (in the two-dimensional display mode) in the display unit according to the embodiment. In the case where only the second light source 7 is maintained in the ON (turned-on) state, as illustrated in FIG. 2, ideally, the second illumination light L10 equally passes through the total reflection region 32 and the scattering regions 31 of the light guide plate 3 to uniformly exit from the light guide plate 3 through substantially the entire first internal reflection plane 3A. However, in actuality, the second illumination light L10 is scattered and passed through the scattering regions 31 or is scattered and reflected by the scattering regions 31. Therefore, compared to the total reflection region 32, emission directions of light rays vary in positions corresponding to the scattering regions 31 to reduce the luminance of the light rays exiting from the light guide plate 3, thereby causing a nonuniform luminance distribution. FIG. 3A illustrates a state of emission of light rays in the two-dimensional display mode in consideration of scattering and transmission or scattering and reflection in the scattering regions 31 in the above-described manner. FIG. 3B illustrates a luminance distribution in the X direction in the state of emission of light rays in FIG. 3A.

As illustrated in FIG. 3B, luminance declines in positions corresponding to the scattering regions 31. In particular, when the number of perspectives for three-dimensional display is increased, the scattering regions 31 are spaced more largely in the horizontal direction, that is, the scattering regions 31 are periodically positioned at longer intervals in the horizontal direction. In this case, a decline in luminance occurs in positions located at longer intervals, and the decline in luminance is visually observed more easily. In particular, when the arrangement pattern of the scattering regions 31 is as illustrated in the above-described comparative examples, the scattering regions 31 are continuously distributed without gaps in between in the first oblique direction 51; therefore, the decline in luminance is easily observed.

### EXAMPLE OF ARRANGEMENT PATTERN OF SCATTERING REGIONS 31 ALLOWING A DECLINE IN LUMINANCE TO BE LESS OBSERVABLE

FIGS. 12 and 13 illustrate a specific example of an arrangement pattern of the scattering regions 31 allowing the above-described decline in luminance to be less observable. The assignment pattern of the perspective images illustrated in FIG. 12 is similar to that in FIG. 8. In this specific example, as illustrated in FIG. 13, a plurality of scattering regions 63 with an oblique shape obliquely arranged to extend in a second oblique direction 52 which is opposite to the first oblique direction 51 with respect to the vertical direction (the Y direction) are discontinuously distributed in the first oblique direction 51 to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 12. The height (vertical length) h1 of the scattering region 63 with the oblique shape is substantially equal to the height of each of the respective color pixels 11R, 11G, and 11B. The width (horizontal length) D1 of the scattering region 63 with the oblique shape is, for example, approximately 0.5 times to 1.5 times as large as that of each of the respective color pixels 11R, 11G, and 11B. It is to be noted that, in FIG. 12, only one scattering region group is illustrated as a representative; however, a plurality of scattering region groups are distributed as a whole in the horizontal direction. Therefore, when three-dimensional display is performed, display substantially equivalent to display with use of the configuration illustrated in FIGS. 8 and 9 is performed. To perform display substantially equivalent to display with use of the configuration illustrated in FIGS. 8 and 9 for three-dimensional display, it is desirable that the width of the scattering region 63 with the oblique shape be substantially equal to that of the scattering region 61 with the oblique shape in the configuration illustrated in FIGS. 8 and 9, and an area of each scattering region 63 be substantially equal to that of the scattering region 61.

In this specific example, as illustrated in FIG. 13, a center line passing through both a midpoint P1 and a midpoint P2 on a top side and a bottom side, respectively, of the scattering region 63 with the oblique shape is parallel to the second oblique direction 52. In this specific example, the first oblique direction 51 is a direction inclined at a first angle α with respect to the vertical direction, and the second oblique direction 52 is a direction inclined at a second angle—α laterally reverse to the first angle α. With such a configuration, a gap 53 is formed between two scattering regions 63 with the oblique shape adjacent to each other in the first oblique direction 51. Compared to the configuration in the above-described comparative examples, the gap 53 allows the scattering regions 31 to be distributed in a plane parallel to the image display plane, and accordingly, a decline in luminance is less likely to be visually observed.

It is to be noted that the second oblique direction 52 is not necessarily oriented at an angle perfectly bilaterally symmetric (line-symmetric) to the first oblique direction 51 with respect to the vertical direction. In other words, the second oblique direction 52 may be oriented at an angle having an absolute value different from an absolute value of the angle with respect to the vertical direction, as long as the second oblique direction 52 is an angular direction opposite to the first oblique direction 51 with respect to the vertical direction.

### [Effects]

As described above, in the display unit according to the embodiment, the scattering regions 31 and the total reflection region 32 are disposed on the second internal reflection plane 3B of the light guide plate 3, and the light guide plate 3 allows the first illumination light from the first light source 2 and the second illumination light L10 from the second light source 7 to selectively exit therefrom; therefore, the light guide plate 3 equivalently functions as a parallax barrier. Thus, compared to the parallax barrier system stereoscopic display unit in related art, the number of components is reduced, and space saving is achievable.

Moreover, in the display unit according to the embodiment, the scattering regions 31 extend in the second oblique direction 52 opposite to the first oblique direction 51 with respect to the vertical direction; therefore, specifically a luminance distribution in two-dimensional display is improved.

### 2. Second Embodiment

Next, a display unit according to a second embodiment of the disclosure will be described below. It is to be noted that like components are denoted by like numerals as of the display unit according to the first embodiment and will not be further described.

In the embodiment, a plurality of modifications of the display unit according to the first embodiment, in particular, modifications of the arrangement pattern of the scattering regions 31 will be described below.

### [First Modification]

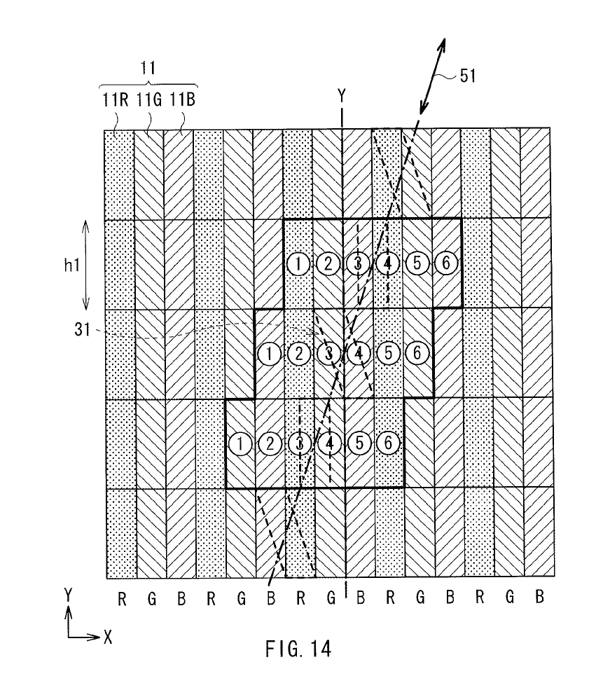

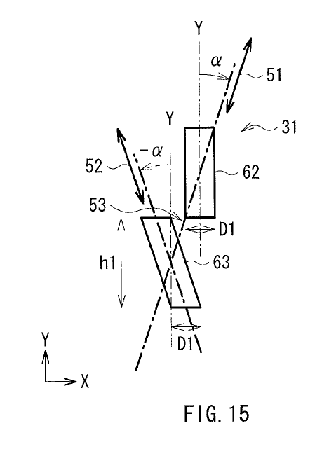

FIGS. 14 and 15 illustrate a first modification of the arrangement pattern of the scattering regions 31. The assignment pattern of the perspective images illustrated in FIG. 14 is similar to that in FIG. 8. In the first modification, the arrangement pattern of the scattering regions 31 is a pattern formed through combining the above-described configuration example illustrated in FIGS. 10 and 11 and the above-described configuration example illustrated in FIGS. 12 and 13. In the first modification, as illustrated in FIG. 15, a plurality of scattering regions 63 with an oblique shape obliquely arranged to extend in the second oblique direction 52 and a plurality of scattering regions 62 with a rectangular shape extending in the vertical direction (the Y direction) are discontinuously distributed in the first oblique direction 51 to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 14. Heights (vertical lengths) h1 of the scattering region 52 with the rectangular shape and the scattering region 63 with the oblique shape each are substantially equal to the height of each of the respective color pixels 11R, 11G, and 11B. Widths (horizontal lengths) D1 of the scattering region 62 with the rectangular shape and the scattering region 63 with the oblique shape each are, for example, approximately 0.5 times to 1.5 times as large as the width of each of the respective color pixels 11R, 11G, and 11B. It is to be noted that, in FIG. 14, only one scattering region group is illustrated as a representative; however, a plurality of scattering region groups are distributed as a whole in the horizontal direction. Therefore, in the case where three-dimensional display is performed, display substantially equivalent to display with use of the configuration illustrated in FIGS. 8 and 9 is performed. To perform display substantially equivalent to display with use of the configuration illustrated in FIGS. 8 and 9 for three-dimensional display, it is desirable that the widths of the scattering region 62 with the rectangular shape and the scattering region 63 with the oblique shape be substantially equal to that of the scattering region 61 with the oblique shape in the configuration illustrated in FIGS. 8 and 9, and an area of each scattering region 62 with the rectangular shape or each scattering region 63 with the oblique shape be substantially equal to that of the scattering region 61.

In the first modification, as illustrated in FIG. 15, the scattering region 62 with the rectangular shape and the scattering region 63 with the oblique shape are arranged adjacent to each other in the first oblique direction 51. With such a configuration, a gap 53 is formed between the scattering region 62 with the rectangular shape and the scattering region 63 with the oblique shape adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

### [Second Modification]

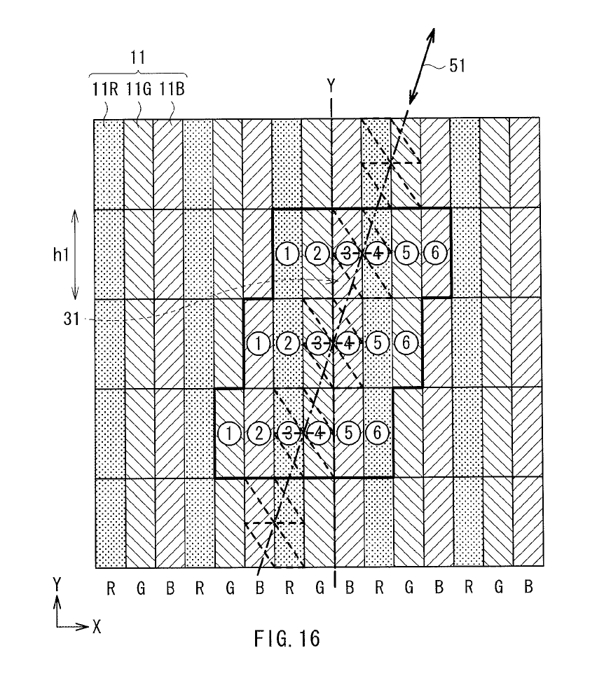

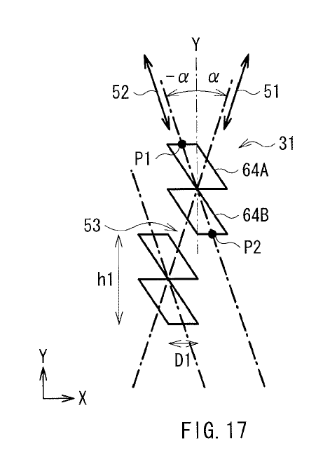

FIGS. 16 and 17 illustrate a second modification of the arrangement pattern of the scattering regions 31. The assignment pattern of the perspective images illustrated in FIG. 16 is similar to that in FIG. 8. In the second modification, the scattering region 63 with the oblique shape in the above-described configuration example in FIGS. 12 and 13 is partitioned into two sub-regions. In the second modification, as illustrated in FIG. 17, the scattering regions 31 each are configured of two sub-regions 64A and 64B each having a predetermined unit length. The predetermined unit length here corresponds to the height (the vertical length) h1 of the scattering region 63 with the oblique shape in FIG. 13, and is substantially equal to the height of each of the respective color pixels 11R, 11G, and 11B. In the second modification, as illustrated in FIG. 17, combinations of two sub-regions 64A and 64B are discontinuously distributed in the first oblique direction 51 as a whole to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 16. The width (horizontal length) D1 of each of the two sub-regions 64A and 64B is, for example, approximately 0.5 times to 1.5 times as large as the width of each of the respective color pixels 11R, 11G, and 11B. It is to be noted that, in FIG. 16, only one scattering region group is illustrated as a representative; however, a plurality of scattering region groups are distributed as a whole in the horizontal direction. Therefore, when three-dimensional display is performed, display substantially equivalent to display with use of the configuration illustrated in FIGS. 8 and 9 is performed. To perform display substantially equivalent to display with use of the configuration illustrated in FIGS. 8 and 9 for three-dimensional display, it is desirable that the width of each of the two sub-regions 64A and 64B be substantially equal to that of the scattering region 61 with the oblique shape in the configuration illustrated in FIGS. 8 and 9, and a total area of the two sub-regions 64A and 64B be substantially equal to the area of the scattering region 61. It is to be noted that an example in which the scattering regions 31 each are configured of two sub-regions 64A and 64B each having the predetermined unit length is illustrated here; however, the scattering regions 31 each may be partitioned into three or more sub-regions.

In the second modification, as illustrated in FIG. 17, a center line passing through both the midpoint P1 and the midpoint P2 on a top side (a top side of the sub-region 64A) and a bottom side (a bottom side of the sub-region 64B), respectively, of a combination of two sub-regions 64A and 64B is parallel to the second oblique direction 52. With such a configuration, the gap 53 is formed between the scattering regions 31 adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

### [Third Modification]

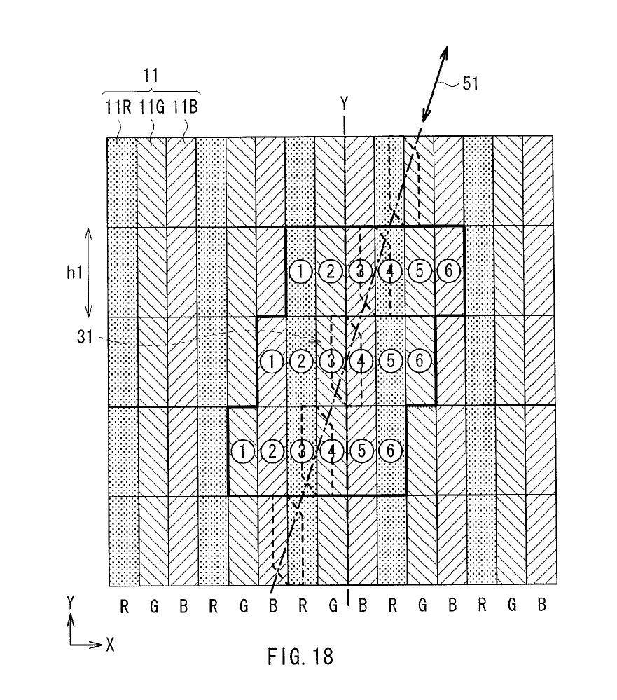

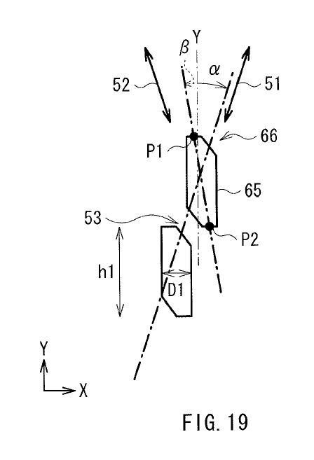

FIGS. 18 and 19 illustrate a third modification of the arrangement pattern of the scattering regions 31. The assignment pattern of the perspective images illustrated in FIG. 18 is similar to that in FIG. 8. In the third modification, the scattering regions 31 each have a shape formed through cutting away a portion of the scattering region 62 with the rectangular shape in the above-described configuration example in FIGS. 10 and 11. In the third modification, as illustrated in FIG. 19, a plurality of scattering regions 65 with a cut portion 66 in the first oblique direction 51 are discontinuously distributed in the first oblique direction 51 to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 18. The height (vertical length) h1 of the scattering region 65 with the cut portion 66 is substantially equal to the height of each of the respective color pixels 11R, 11G, and 11B. The width (horizontal length) D1 of the scattering region 65 is, for example, approximately 0.5 times to 1.5 times as large as the width of each of the respective color pixels 11R, 11G, and 11B. It is to be noted that, in FIG. 18, only one scattering region group is illustrated as a representative; however, a plurality of scattering region groups are distributed as a whole in the horizontal direction. Therefore, when three-dimensional display is performed, display substantially equivalent to display with use of the configuration illustrated in FIGS. 8 and 9 is performed.

In the third modification, as illustrated in FIG. 17, a center line passing through both the midpoint P1 and the midpoint P2 on a top side and a bottom side, respectively, of the scattering region 65 with the cut portion 66 is parallel to the second oblique direction 52. In the third modification, the first oblique direction 51 is a direction inclined at the first angle α with respect to the vertical direction, and the second oblique direction 52 is a direction inclined at a second angle β laterally reverse to the first angle α. With such a configuration, the gap 53 is formed between the scattering regions 65 adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

### [Fourth Modification]

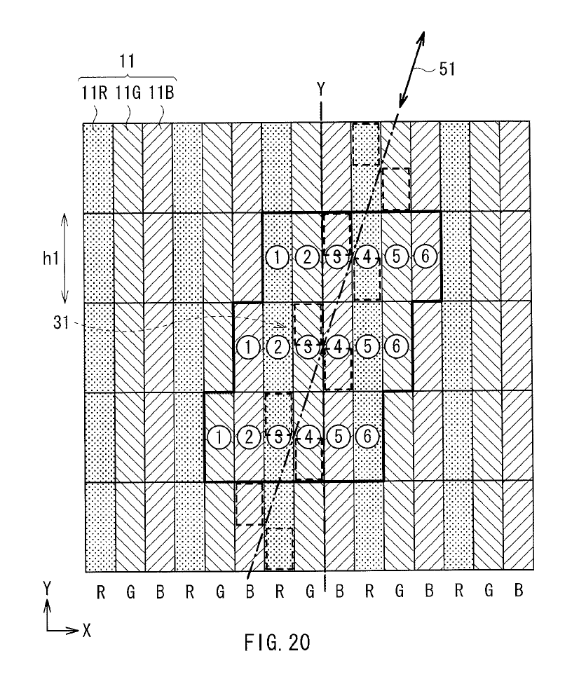

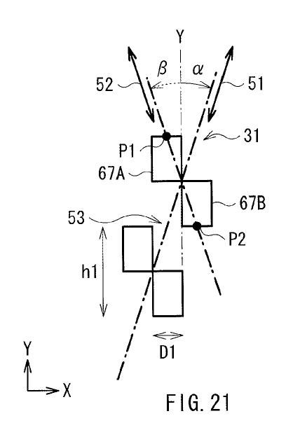

FIGS. 20 and 21 illustrate a fourth modification of the arrangement pattern of the scattering regions 31. The assignment pattern of the perspective images illustrated in FIG. 20 is similar to that in FIG. 8. In the fourth modification, the scattering region 62 with the rectangular shape in the above-described configuration example in FIGS. 10 and 11 is partitioned into two sub-regions. In the fourth modification, as illustrated in FIG. 21, the scattering regions 31 each are configured of two sub-regions 67A and 67B each having a predetermined unit length. The predetermined unit length here corresponds to the height (the vertical length) h1 of the scattering region 62 with the rectangular shape in FIG. 11, and is substantially equal to the height of each of the respective color pixels 11R, 11G, and 11B. In the fourth modification, as illustrated in FIG. 21, combinations of two sub-regions 67A and 67B are discontinuously distributed as a whole in the first oblique direction 51 to form one scattering region group. The one scattering region group is distributed to be astride pixels in a central region of one stereoscopic pixel when viewed from the direction perpendicular to the arrangement plane of the pixels 11, i.e., a pixel for the third perspective and a pixel for the fourth perspective in an example in FIG. 20. The width (horizontal length) D1 of each of the two sub-regions 67A and 67B is, for example, approximately 0.5 times to 1.5 times as large as the width of each of the respective color pixels 11R, 11G, and 11B. It is to be noted that, in FIG. 20, only one scattering region group is illustrated as a representative; however, a plurality of scattering region groups are distributed as a whole in the horizontal direction. Therefore, when three-dimensional display is performed, display substantially equivalent to display with use of the configuration illustrated in FIGS. 10 and 11 is performed. To perform display substantially equivalent to display with use of the configuration illustrated in FIGS. 10 and 11 for three-dimensional display, it is desirable that the width of each of the two sub-regions 67A and 67B be substantially equal to that of the scattering region 62 with the rectangular shape in the configuration illustrated in FIGS. 10 and 11, and a total area of the two sub-regions 67A and 67B be substantially equal to the area of the scattering region 62.

In the fourth modification, as illustrated in FIG. 21, a center line passing through both the midpoint P1 and the midpoint P2 on a top side (a top side of the sub-region 67A) and a bottom side (a bottom side of the sub-region 67B), respectively, of a combination of two sub-regions 67A and 67B is parallel to the second oblique direction 52. In the fourth modification, the first oblique direction 51 is a direction inclined at the first angle α with respect to the vertical direction, and the second oblique direction 52 is a direction inclined at the second angle β laterally reverse to the first angle α. With such a configuration, the gap 53 is formed between the scattering regions 31 adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

### [Fifth Modification]

In the fourth modification, the scattering regions 31 each are configured of two sub-regions 67A and 67B each having the predetermined unit length; however, the scattering regions 31 each may be configured of three or more sub-regions.

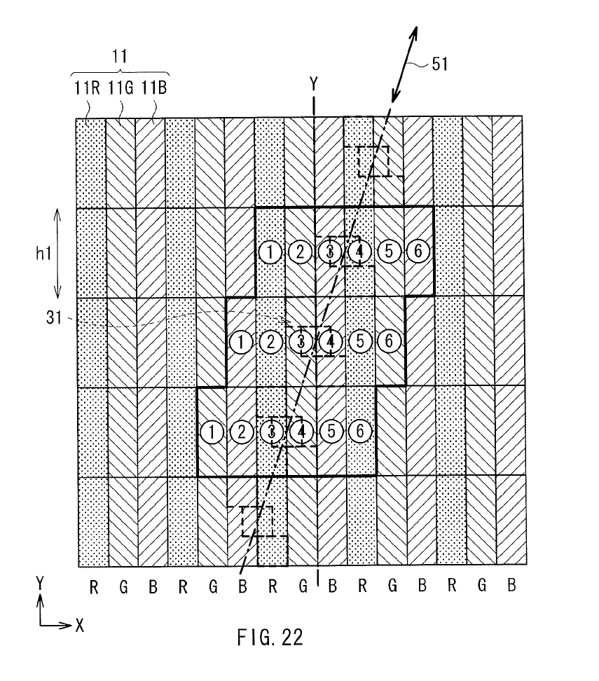

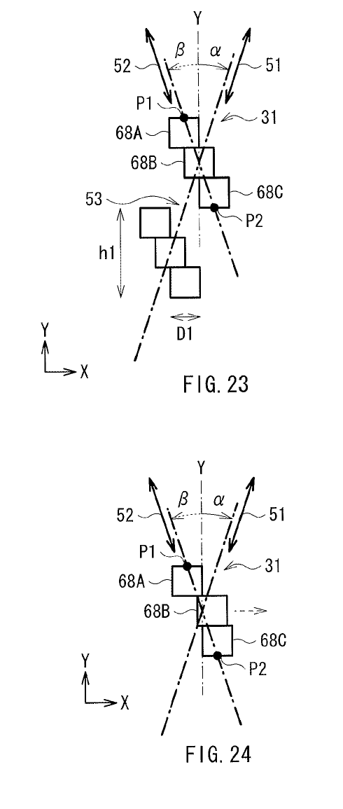

FIGS. 22 and 23 illustrate a fifth modification of the arrangement pattern of the scattering regions 31. The assignment pattern of the perspective images illustrated in FIG. 22 is similar to that in FIG. 8. In the fifth modification, the scattering region 62 with the rectangular shape in the above-described configuration example in FIGS. 10 and 11 is partitioned into three sub-regions. In the fifth modification, as illustrated in FIG. 23, the scattering regions 31 each are configured of three sub-regions 68A, 68B, and 68C each having a predetermined unit length. The predetermined unit length here corresponds to the height (the vertical length) h1 of the scattering region 62 with the rectangular shape in FIG. 11, and is substantially equal to the height of each of the respective color pixels 11R, 11G, and 11B. In the fifth modification, as illustrated in FIG. 23, combinations of three sub-regions 68A, 68B, and 68C are discontinuously distributed as a whole in the first oblique direction 51 to form one scattering region group. The one scattering region group is distributed to be astride pixels in a central region of one stereoscopic pixel when viewed from a direction perpendicular to the arrangement plane of the pixels 11, i.e., a pixel for the third perspective and a pixel for the fourth perspective in an example in FIG. 22. The width (horizontal length) D1 of each of the three sub-regions 68A, 68B, and 68C is, for example, 0.5 times to 1.5 times as large as the width of each of the respective color pixels 11R, 11G, and 11B. It is to be noted that only one scattering region group is illustrated as a representative in FIG. 22; however, a plurality of scattering region groups are distributed as a whole in the horizontal direction. Therefore, when three-dimensional display is performed, display substantially equivalent to display with use of the configuration illustrated in FIGS. 10 and 11 is performed. To perform display substantially equivalent to display with use of the configuration illustrated in FIGS. 10 and 11 for three-dimensional display, it is desirable that the width of each of the three sub-regions 68A, 68B, and 68C be substantially equal to that of the scattering region 62 with the rectangular shape in the configuration illustrated in FIGS. 10 and 11, and a total area of the three sub-regions 68A, 68B, and 68C be substantially equal to the area of the scattering region 62.

In the fifth modification, as illustrated in FIG. 23, a center line passing through both the midpoint P1 and the midpoint P2 on a top side (a top side of the sub-region 68A) and a bottom side (a bottom side of the sub-region 68C) of a combination of three sub-regions 68A, 68B, and 68C is parallel to the second oblique direction 52. In the fifth modification, the first oblique direction 51 is a direction inclined at the first angle α with respect to the vertical direction, and the second oblique direction 52 is a direction inclined at the second angle β laterally reverse to the first angle α. With such a configuration, the gap 53 is formed between the scattering regions 31 adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

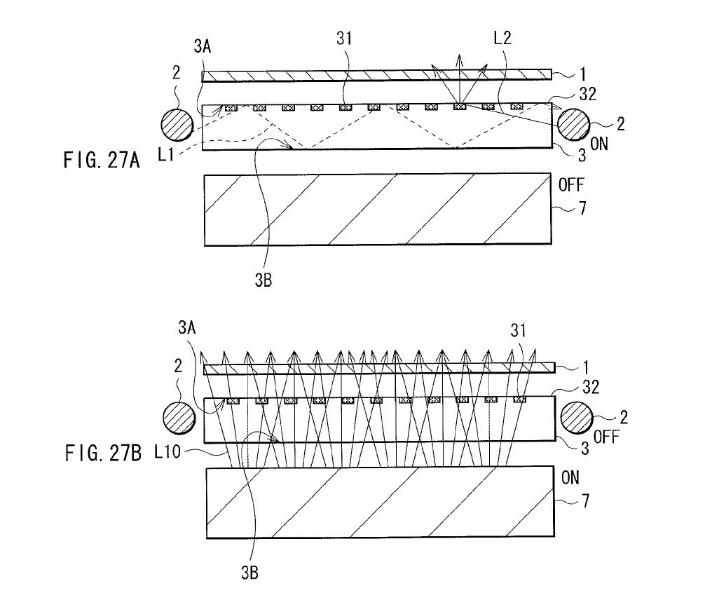

It is to be noted that, in FIG. 23, the sub-region 68B located in the middle of three sub-regions 68A, 68B, and 68C is equally located, in the horizontal direction, with respect to the sub-region 68A located at the top and the sub-region 68C located at the bottom. On the other hand, for example, as illustrated in FIG. 27, the sub-region 68B located in the middle may be unequally located with respect to the sub-region 68A located at the top and the sub-region 68C located at the bottom.

In addition, a gap may be formed between three sub-regions 68A, 68B, and 68C. Moreover, it is not necessary for the three sub-regions 68A, 68B, and 68C to have the same shape. The three sub-regions 68A, 68B, and 68C may have shapes different from one another.

### [Sixth Modification]

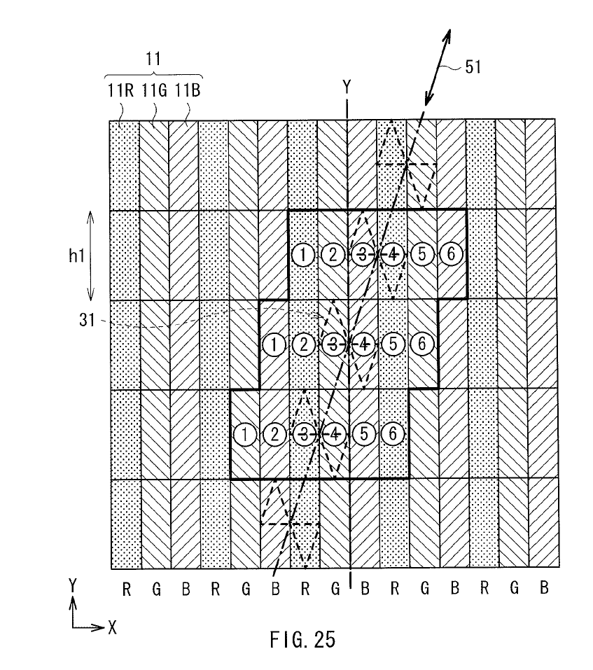

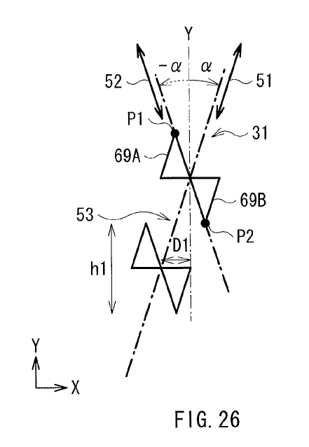

FIGS. 25 and 26 illustrate a sixth modification of the arrangement pattern of the scattering regions 31. The assignment pattern of the perspective images illustrated in FIG. 25 is similar to that in FIG. 8. In the sixth modification, the scattering region 62 with the rectangular shape in the above-described configuration example in FIGS. 10 and 11 is partitioned into two sub-regions with a triangular shape. In the sixth modification, as illustrated in FIG. 26, the scattering regions 31 each are configured of two sub-regions 69A and 69B each having a predetermined unit length. The predetermined unit length here corresponds to the height (the vertical length) h1 of the scattering region 62 with the rectangular shape in FIG. 11, and is substantially equal to the height of each of the respective color pixels 11R, 11G, and 11B. The upper sub-region 69A has a triangular shape with an apex located at the top. The lower sub-region 69B has a reversed triangular shape with an apex located at the bottom. In the sixth modification, as illustrated in FIG. 26, combinations of two sub-regions 69A and 69B are discontinuously distributed in the first oblique direction 51 as a whole to form one scattering region group. The one scattering region group is distributed to be astride pixels in a central region of one stereoscopic pixel when viewed from the direction perpendicular to the arrangement plane of the pixels 11, i.e., a pixel for the third perspective and a pixel for the fourth perspective in an example in FIG. 25. The width (horizontal length) D1 of each of the two sub-regions 69A and 69B is, for example, approximately 0.5 times to 1.5 times as large as the width of each of the respective color pixels 11R, 11G, and 11B. It is to be noted that, in FIG. 25, only one scattering region group is illustrated as a representative; however, a plurality of scattering region groups are distributed as a whole in the horizontal direction.

In the sixth modification, as illustrated in FIG. 26, a center line passing through both the midpoint P1 and the midpoint P2 on a top side (a top side of the sub-region 69A) and a bottom side (a bottom side of the sub-region 69B), respectively, of a combination of two sub-regions 69A and 69B is parallel to the second oblique direction 52. With such a configuration, the gap 53 is formed between the scattering regions 31 adjacent to each other in the first oblique direction 51. Compared to the configurations of the above-described comparative examples, the gap 53 allows the scattering regions 31 to be distributed in a plane parallel to the image display plane, and accordingly, a decline in luminance is less likely to be visually observed.

It is to be noted that, in the first embodiment and the respective modifications, the case where the number of perspectives for three-dimensional display is six is described as an example; however, the number of perspectives may be larger or smaller than six. Moreover, the above modifications may be arbitrarily combined.

### 3. Third Embodiment

Next, a display unit according to a third embodiment of the disclosure will be described below. It is to be noted that like components are denoted by like numerals as of the display unit according to the first or second embodiments and will not be further described.

### [Entire Configuration of Display Unit]

In the first embodiment, a configuration example in which the scattering regions 31 and the total reflection region 32 are disposed on the second internal reflection plane 3B in the light guide plate 3 is described; however, they may be disposed on the first internal reflection plane 3A.

FIGS. 27A and 27B illustrate a configuration example of the display unit according to the third embodiment of the disclosure. As in the case of the display unit in FIG. 1, the display unit is capable of selectively and arbitrarily performing switching between the two-dimensional display mode and the three-dimensional display mode. FIG. 27A corresponds to a configuration in the three-dimensional display mode, and FIG. 27B corresponds to a configuration in the two-dimensional display mode. In FIGS. 27A and 27B, states of emission of light rays from the light source device in respective display modes are schematically illustrated.

The entire second internal reflection plane 3B is minor-finished, and allows the first illumination light L1 incident at the incident angle θ1 satisfying the total-reflection condition to be reflected, in a manner of total-internal-reflection. The first internal reflection plane 3A has the scattering regions 31 and the total reflection region 32. As in the case of the first or second embodiment, on the first internal reflection plane 3A, the total reflection region 32 and the scattering regions 31 are arranged in a pattern forming a configuration corresponding to a parallax barrier. In other words, in the three-dimensional display mode, the scattering regions 31 and the total-reflection region 32 function as opening sections (slit sections) and a shielding section, respectively, of a parallax barrier.

The total-reflection region 32 reflects the first illumination light L1 incident at the incident angle θ1 satisfying the total-reflection condition in a manner of total-internal-reflection (reflects the first illumination light L1 incident at the incident angle θ1 larger than a predetermined critical angle α in a manner of total-internal-reflection). The scattering regions 31 allow some or all of light rays, which are incident at an angle corresponding to the incident angle θ1 satisfying a predetermined total-reflection condition in the total reflection region 32, of incident light rays L2 to exit from the light guide plate 3 (the scattering regions 31 allow some or all of light rays incident at an angle corresponding to the incident angle θ1 larger than the predetermined critical angle α to exit from the light guide plate 3). The scattering regions 31 internally reflect some other light rays of the incident light rays L2.

In the display unit illustrated in FIGS. 27A and 27B, to spatially separate a plurality of perspective images displayed on the display section 1, it is necessary to dispose a pixel section of the display section 1 and the scattering regions 31 of the light guide plate 3 to face each other with a predetermined distance in between. In FIGS. 27A and 27B, the display section 1 and the light guide plate 3 are disposed with air in between; however, to keep the predetermined distance between the display section and the light guide plate 3, a spacer may be disposed between the display section 1 and the light guide plate 3.

### [Basic Operation of Display Unit]

In the case where this display unit performs display in the three-dimensional display mode (refer to FIG. 27A), the display section 1 displays an image based on the three-dimensional image data, and the entire second light source 7 is controlled to be in the OFF (turned-off) state. The first light source 2 disposed on a side surface of the light guide plate 3 is controlled to be in the ON (turned-on) state. In this state, the first illumination light L1 from the first light source 2 is reflected repeatedly in a manner of total-internal-reflection between the total reflection region 32 of the first internal reflection plane 3A and the second internal reflection plane 3B to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plate 3 through the scattering regions 31. In the scattering regions 31, some other light rays are internally reflected; however, the light rays exit from the light guide plate 3 through the second internal reflection plane 3B of the light guide plate 3, thereby not contributing to displaying an image. As a result, light rays are emitted only from the scattering regions 31 of the internal reflection plane 3A of the light guide plate 3. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 27B), the display section 1 displays an image based on the two-dimensional image data, and the entire second light source 7 is controlled to be in the ON (turned-on) state. For example, the first light source 2 disposed on the side surface of the light guide plate 3 is not turned on. In this state, the second illumination light L10 from the second light source 7 enters the light guide plate 3 at an angle substantially perpendicular to the light guide plate 3 through the second internal reflection plane 3B. Therefore, the incident angle of the light rays is out of the total-reflection condition in the total reflection region 32; therefore, the light rays exit not only from the scattering regions 31 but also from the total reflection region 32. As a result, light rays are emitted from the entire first internal reflection plane 3A in the light guide plate 3. In other words, the light guide plate 3 functions as a planar light source similar to a typical backlight. Therefore, two-dimensional display by a backlight system in which a typical backlight is disposed on the back side of the display section 1 is equivalently performed.

It is to be noted that, when display is performed in the two-dimensional display mode, the first light source 2 disposed on the side surface of the light guide plate 3 may be also controlled to be in the ON (turned-on) state together with the second light source 7. Moreover, in the case where display is performed in the two-dimensional display mode, the first light source 2 may be switched between the turned-off state and the turned-on state as necessary. Therefore, for example, in the case where there is a difference in a luminance distribution between the scattering regions 31 and the total-reflection region 32 when only the second light source 7 is turned on, the lighting state of the first light source 2 is appropriately adjusted (ON/OFF control or the lighting amount of the first light source 2 is adjusted) to allow an entire luminance distribution to be optimized.

In this embodiment, when the scattering regions 31 have a configuration similar to those in the examples illustrated in FIGS. 12 to 26, the luminance distribution is optimized.

### [Effects]

As described above, in the display unit according to the present embodiment, the scattering regions 31 and the total reflection region 32 are disposed on the first internal reflection plane 3A of the light guide plate 3, and the first illumination light from the first light source 2 and the second illumination light L10 from the second light source 7 selectively exit from the light guide plate 3; therefore, the light guide plate 3 equivalently functions as a parallax barrier. Thus, compared to the parallax barrier system stereoscopic display unit in related art, the number of components is reduced, and space saving is achievable.

Moreover, as in the case of the first or second embodiment, in the display unit according to the present embodiment, the scattering regions 31 extend in the second oblique direction 52 opposite to the first oblique direction 51 with respect to the vertical direction; therefore, specifically a luminance distribution in two-dimensional display is improved.

### 4. Fourth Embodiment

Next, a display unit according to a fourth embodiment of the disclosure will be described below. It is to be noted that like components are denoted by like numerals as of the display units according to the first to third embodiments and will not be further described.

### [Entire Configuration of Display Unit]

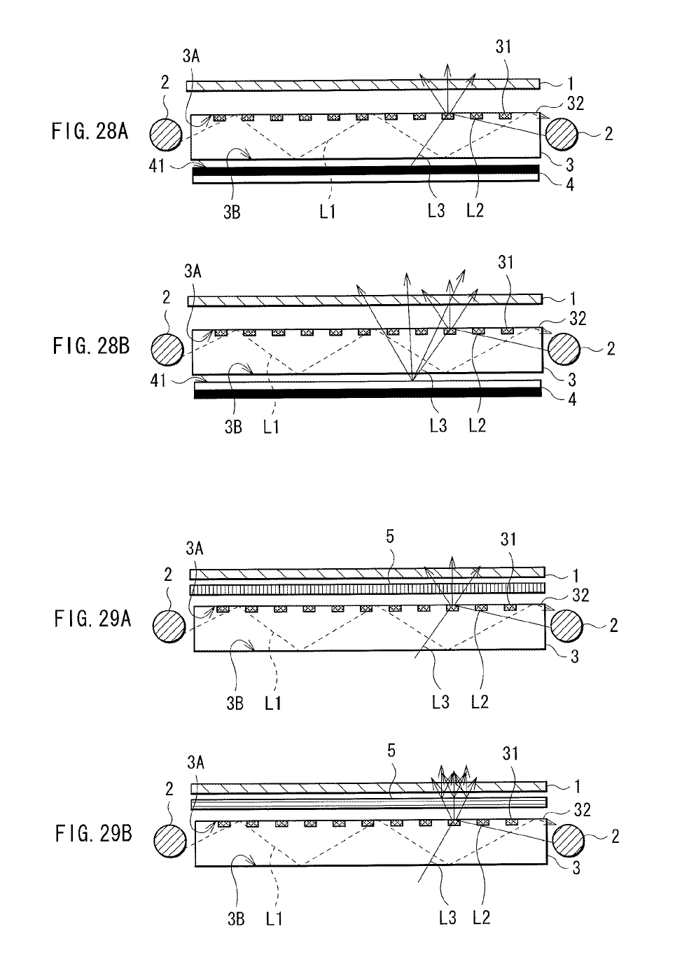

FIGS. 28A and 28B illustrate a configuration example of the display unit according to the fourth embodiment of the disclosure. The display unit includes an electronic paper 4 instead of the second light source 7 in the display unit illustrated in FIGS. 27A and 27B.

The display unit is capable of selectively and arbitrarily performing switching between the two-dimensional (2D) display mode on an entire screen and the three-dimensional (3D) display mode on the entire screen. FIG. 28A corresponds to a configuration in the three-dimensional display mode, and FIG. 28B corresponds to a configuration in the two-dimensional display mode. In FIGS. 28A and 28B, states of emission of light rays from the light source device in respective display modes are schematically illustrated.

The electronic paper 4 is disposed to face a side (a side where the second internal reflection plane 3B is formed) of the light guide plate 3. The side is opposite to a direction where the first illumination light L1 exits. The electronic paper 4 is an optical device allowed to be selectively switched, in a mode of action on incident light rays, between two modes, i.e., a light absorption mode and a scattering-reflection mode. The electronic paper 4 is configured of, for example, a particle migration type display device of an electrophoresis system or an electronic liquid powder system. In the particle migration type display device, for example, positively-charged black particles and negatively-charged white particles are dispersed between a pair of substrates facing each other, and the particles are migrated according to a voltage applied between the substrates to perform display in a black state or a white state. In particular, in the electrophoresis system, the particles are dispersed in a solution, and in the electronic liquid powder system, the particles are dispersed in a gas. The above-described light absorption mode corresponds to the case where an entire display plane 41 of the electronic paper 4 is maintained in a black state of display as illustrated in FIG. 28A, and the scattering-reflection mode corresponds to the case where the entire display plane 41 of the electronic paper 4 is maintained in a white state of display as illustrated in FIG. 28B. In the case where the display section 1 displays a plurality of perspective images based on three-dimensional image data (in the case of the three-dimensional display mode), in the electronic paper 4, the mode of action on incident light rays is maintained in the light absorption mode. In the case where the display section 1 displays an image based on two-dimensional image data (in the case of two-dimensional display mode), in the electronic paper 4, the mode of action on incident light rays is maintained in the scattering-reflection mode.

In the display unit illustrated in FIGS. 28A and 28B, to spatially separate a plurality of perspective images displayed on the display section 1, it is necessary to dispose a pixel section of the display section 1 and the scattering regions 31 to face each other with a predetermined distance in between. In FIGS. 28A and 28B, the display section 1 and the light guide plate 3 are disposed with air in between; however, to keep the predetermined distance between the display section 1 and the light guide plate 3, a spacer may be disposed between the display section 1 and the light guide plate 3.

### [Operation of Display Unit]

In the display unit, in the case where display is performed in the three-dimensional display mode (refer to FIG. 28A), the display section 1 displays an image based on the three-dimensional image data, and the entire display plane 41 of the electronic paper 4 is maintained in the black state of display (the light absorption mode). In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plate 3 through the scattering regions 31. The scattering regions 31 internally reflect some other light rays L3, and the light rays L3 enter the display plane 41 of the electronic paper 4 through the second internal reflection plane 3B of the light guide plate 3. In this case, the entire display plane 41 of the electronic paper 4 is maintained in the black state of display; therefore, the light rays L3 are absorbed by the display plane 41. As a result, in the light guide plate 3, light rays are emitted from only the scattering regions 31 of the first internal reflection plane 3A. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 28B), the display section 1 displays an image based on the two-dimensional image data, and the entire display plane 41 of the electronic paper 4 is maintained in the white state of display (the scattering-reflection mode). In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A in the light guide plate 3 exit from the light guide plate 3 through the scattering regions 31. The scattering regions 31 internally reflect some other light rays L3, and the light rays L3 enter the display plane 41 of the electronic paper 4 through the second internal reflection plane 3B of the light guide plate 3. In this case, the entire display plane 41 of the electronic paper 4 is maintained in the white state of display; therefore, the light rays L3 are scattered and reflected by the display plane 41. The light rays scattered and reflected by the display plane 41 enter the light guide plate 3 again through the second internal reflection plane 3B; however, the incident angle of the light rays is out of the total-reflection condition in the total reflection region 32, and the light rays exit not only from the scattering regions 31 but also from the total reflection region 32. As a result, light rays are emitted from the entire first internal reflection plane 3A in the light guide plate 3. In other words, the light guide plate 3 functions as a planar light source similar to a typical backlight. Therefore, two-dimensional display by a backlight system in which a typical backlight is disposed on the back side of the display section 1 is equivalently performed.

### [Effects]

As described above, in the display unit according to the present embodiment, the scattering regions 31 and the total reflection region 32 are disposed on the first internal reflection plane 3A of the light guide plate 3; therefore, the light guide plate 3 equivalently functions as a parallax barrier. Thus, compared to the parallax barrier system stereoscopic display unit in related art, the number of components is reduced, and space saving is achievable. Moreover, switching between the two-dimensional display mode and the three-dimensional display mode is easily performed only through switching the display state of the electronic paper 4.

Moreover, as in the case of the first or second embodiment, in the display unit according to the present embodiment, the scattering regions 31 extend in the second oblique direction 52 opposite to the first oblique direction 51 with respect to the vertical direction; therefore, specifically a luminance distribution in two-dimensional display is improved.

### 5. Fifth Embodiment

Next, a display unit according to a fifth embodiment of the disclosure will be described below. It is to be noted that like components are denoted by like numerals as of the display units according to the first to fourth embodiments and will not be further described.

### [Entire Configuration of Display Unit]

FIGS. 29A and 29B illustrate a configuration example of the display unit according to the fifth embodiment of the disclosure. As in the case of the display unit illustrated in FIGS. 28A and 28B, the display unit is capable of selectively and arbitrarily performing switching between the two-dimensional display mode and the three-dimensional display mode. FIG. 29A corresponds to a configuration in the three-dimensional display mode, and FIG. 29B corresponds to a configuration in the two-dimensional display mode. In FIGS. 29A and 29B, states of emission of light rays from the light source device in respective display modes are schematically illustrated.

In the display unit, the light source device includes a polymer diffuser plate 5 instead of the electronic paper 4 in the display unit illustrated in FIGS. 28A and 28B. The display unit has a configuration similar to that of the display unit in FIGS. 28A and 28B, except for the above-described configuration. The polymer diffuser plate 5 is configured with use of a polymer-dispersed liquid crystal. The polymer diffuser plate 5 is disposed to face the light guide plate 3 in a direction where the first illumination light L1 exits (a side where the first internal reflection plane 3A is formed). The polymer diffuser plate 5 is an optical device allowed to be selectively switched, in a mode of action on incident light rays, between two modes, i.e., a transparent mode and a scattering-transmission mode.

### [Basic Operation of Display Unit]

In the display unit, when display is performed in the three-dimensional display mode (refer to FIG. 29A), the display section 1 displays an image based on the three-dimensional image data, and the entire polymer diffuser plate 5 is maintained in the transparent mode. In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A of the light guide plate 3 exit from the light guide plate 3 through the scattering regions 31. The light rays exiting from the light guide plate 3 through the scattering regions 31 enter the polymer diffuser plate 5. However, as the entire polymer diffuser plate 5 is maintained in the transparent mode, the light rays pass through the polymer diffuser plate 5 while maintaining their emission angles from the scattering regions 31 to enter the display section 1. The scattering regions 31 internally reflect some other light rays L3; however, the light rays L3 exit from the light guide plate 3 through the second internal reflection plane 3B of the light guide plate 3, thereby not contributing to displaying an image. As a result, light rays are emitted only from the scattering regions 31 of the first internal reflection plane 3A of the light guide plate 3. In other words, a surface of the light guide plate 3 equivalently functions as a parallax barrier with the scattering regions 31 as opening sections (slit sections) and the total reflection region 32 as a shielding section. Therefore, three-dimensional display by a parallax barrier system in which the parallax barrier is disposed on the back side of the display section 1 is equivalently performed.

On the other hand, in the case where display is performed in the two-dimensional display mode (refer to FIG. 29B), the display section 1 displays an image based on the two-dimensional image data, and the entire polymer diffuser plate 5 is maintained in the scattering-transmission mode. In this state, the first illumination light L1 from the first light source 2 is reflected repeatedly in a manner of total-internal-reflection between the total reflection region 32 of the first internal reflection plane 3A and the second internal reflection plane 3B in the light guide plate 3 to be guided from a side surface where the first light source 2 is disposed to the other side surface facing the side surface and then to be emitted from the other side surface. On the other hand, some light rays out of the total-reflection condition of the light rays L2 incident to the scattering regions 31 of the first internal reflection plane 3A in the light guide plate 3 exit from the light guide plate 3 through the scattering regions 31. In this case, light rays exiting from the light guide plate 3 through the scattering regions 31 enter the polymer diffuser plate 5. However, as the entire polymer diffuser plate 5 is maintained in the scattering-transmission mode, light rays incident to the display section 1 are scattered by the entire polymer diffuser plate 5. As a result, the light source device as a whole functions as a planar light source similar to a typical backlight. Therefore, two-dimensional display by a backlight system in which a typical backlight is disposed on the back side of the display section 1 is equivalently performed.

In the present embodiment, as in the case of the first or second embodiment, the scattering regions 31 extend in the second oblique direction 52 opposite to the first oblique direction 51 with respect to the vertical direction; therefore, specifically a luminance distribution in two-dimensional display is improved.

### 6. Other Embodiments

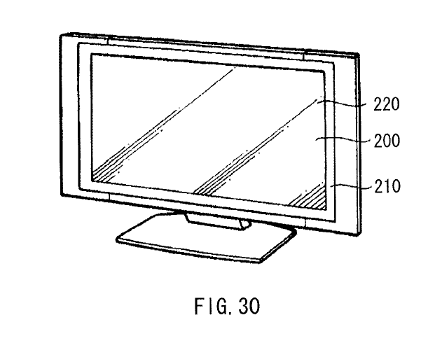

Although the present disclosure is described referring to the above-described embodiments, the disclosure is not limited thereto, and may be variously modified. For example, the display units according to the above-described embodiments each are applicable to various electronic apparatuses having a display function. FIG. 30 illustrates an appearance configuration of a television as an example of such an electronic apparatus. The television includes an image display screen section 200 including a front panel 210 and a filter glass 220.

Moreover, for example, the disclosure may have the following configurations.

(1) A display unit including:

a display section including a plurality of pixels arranged; and

a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate,

in which each of the scattering region groups includes a plurality of scattering regions distributed as a whole in a first oblique direction with respect to a vertical direction and in a plane parallel to a plane where the pixels are arranged, and

one or more of the plurality of scattering regions extend in a second oblique direction opposite to the first oblique direction with respect to the vertical direction.

(2) The display unit according to (1), in which

a gap is formed between two scattering regions in the plurality of scattering regions, the two scattering regions being adjacent to each other in the first oblique direction.

(3) The display unit according to (1) or (2), in which

a center line of the scattering region, which passes through both a midpoint on a top side of the scattering region and a midpoint on a bottom side thereof, is parallel to the second oblique direction.

(4) The display unit according to any one of (1) to (3), in which

the plurality of scattering regions include a first scattering region and a second scattering region which are arranged adjacent to each other in the first oblique direction, the first scattering region extending in the second oblique direction, and the second scattering region extending in the vertical direction.

(5) The display unit according to any one of (1) to (4), in which

the plurality of scattering regions include a scattering region partitioned into a plurality of sub-regions each having a predetermined unit length, and

the scattering region configured of the plurality of sub-regions extends, as a whole, in the second oblique direction.

(6) The display unit according to any one of (1) to (5), further including a second light source disposed to face the light guide plate, the second light source applying second illumination light toward the light guide plate from a direction different from a light-application direction of the first light source.

(7) The display unit according to (6), in which

the display section selectively switches images to be displayed between perspective images based on three-dimensional image data and an image based on two-dimensional image data, and

the second light source is controlled to be turned off when the perspective images are to be displayed on the display section, and is controlled to be turned on when the image based on the two-dimensional image data is to be displayed on the display section.

(8) The display unit according to (7), in which

the first light source is controlled to be turned on when the perspective images are to be displayed on the display section, and is controlled to be either turned off or turned on when the image based on the two-dimensional image data is to be displayed on the display section.

(9) The display unit according to any one of (1) to (5), further including an optical device disposed to face the light guide plate on a side opposite to an emission direction of the first illumination light, and allowed to be selectively switched, in a mode of action on incident light rays, between a light absorption mode and a scattering-reflection mode.

(10) The display unit according to any one of (1) to (5) further including an optical device disposed to face the light guide plate in an emission direction of the first illumination light, and allowed to be selectively switched, in a mode of action on incident light rays, between a transparent mode and a scattering-transmission mode.

(11) A light source device including:

a first light source emitting first illumination light; and

a light guide plate disposed to face a display section including a plurality of pixel arranged, the light guide plate including a plurality of scattering region groups that allow the first illumination light entering through a side surface of the light guide plate to be scattered and then to exit from the light guide plate,

in which each of the scattering region groups includes a plurality of scattering regions distributed as a whole in a first oblique direction with respect to a vertical direction and in a plane parallel to a plane where the pixels are arranged, and

one or more of the plurality of scattering regions extend in a second oblique direction opposite to the first oblique direction with respect to the vertical direction.

(12) An electronic apparatus including a display unit, the display unit including:

a display section including a plurality of pixels arranged; and

a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate,

in which each of the scattering region groups includes a plurality of scattering regions distributed as a whole in a first oblique direction with respect to a vertical direction and in a plane parallel to a plane where the pixels are arranged, and

one or more of the plurality of scattering regions extend in a second oblique direction opposite to the first oblique direction with respect to the vertical direction.

The present application contains subject matter related to that disclosed in Japanese Priority Patent Application No. 2011-246772 filed in the Japan Patent Office on Nov. 10, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section including a plurality of pixels arranged; and
a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate,
wherein each of the scattering region groups includes a plurality of scattering regions distributed as a whole in a first oblique direction with respect to a vertical direction and in a plane parallel to a plane where the pixels are arranged, and
one or more of the plurality of scattering regions extend in a second oblique direction opposite to the first oblique direction with respect to the vertical direction.

2. The display unit according to claim 1, wherein
a gap is formed between two scattering regions in the plurality of scattering regions, the two scattering regions being adjacent to each other in the first oblique direction.

3. The display unit according to claim 1, wherein
a center line of the scattering region, which passes through both a midpoint on a top side of the scattering region and a midpoint on a bottom side thereof, is parallel to the second oblique direction.

4. The display unit according to claim 1, wherein
the plurality of scattering regions include a first scattering region and a second scattering region which are arranged adjacent to each other in the first oblique direction, the first scattering region extending in the second oblique direction, and the second scattering region extending in the vertical direction.

5. The display unit according to claim 1, wherein
the plurality of scattering regions include a scattering region partitioned into a plurality of sub-regions each having a predetermined unit length, and
the scattering region configured of the plurality of sub-regions extends, as a whole, in the second oblique direction.

6. The display unit according to claim 1, further comprising a second light source disposed to face the light guide plate, the second light source applying second illumination light toward the light guide plate from a direction different from a light-application direction of the first light source.

7. The display unit according to claim 6, wherein
the display section selectively switches images to be displayed between perspective images based on three-dimensional image data and an image based on two-dimensional image data, and
the second light source is controlled to be turned off when the perspective images are to be displayed on the display section, and is controlled to be turned on when the image based on the two-dimensional image data is to be displayed on the display section.

8. The display unit according to claim 7, wherein
the first light source is controlled to be turned on when the perspective images are to be displayed on the display section, and is controlled to be either turned off or turned on when the image based on the two-dimensional image data is to be displayed on the display section.

9. The display unit according to claim 1, further comprising an optical device disposed to face the light guide plate on a side opposite to an emission direction of the first illumination light, and allowed to be selectively switched, in a mode of action on incident light rays, between a light absorption mode and a scattering-reflection mode.

10. The display unit according to claim 1, further comprising an optical device disposed to face the light guide plate in an emission direction of the first illumination light, and allowed to be selectively switched, in a mode of action on incident light rays, between a transparent mode and a scattering-transmission mode.

11. A light source device comprising:
a first light source emitting first illumination light; and
a light guide plate disposed to face a display section including a plurality of pixel arranged, the light guide plate including a plurality of scattering region groups that allow the first illumination light entering through a side surface of the light guide plate to be scattered and then to exit from the light guide plate,
wherein each of the scattering region groups includes a plurality of scattering regions distributed as a whole in a first oblique direction with respect to a vertical direction and in a plane parallel to a plane where the pixels are arranged, and
one or more of the plurality of scattering regions extend in a second oblique direction opposite to the first oblique direction with respect to the vertical direction.

12. An electronic apparatus including a display unit, the display unit comprising:
a display section including a plurality of pixels arranged; and
a light source device disposed to face the display section and to emit light for image display toward the display section, the light source device including a first light source emitting first illumination light, and a light guide plate, the light guide plate including a plurality of scattering region groups that allow the first illumination light entering through a side surface of the light guide plate to be scattered and then to exit from the light guide plate,
wherein each of the scattering region groups includes a plurality of scattering regions distributed as a whole in a first oblique direction with respect to a vertical direction and in a plane parallel to a plane where the pixels are arranged, and
one or more of the plurality of scattering regions extend in a second oblique direction opposite to the first oblique direction with respect to the vertical direction.
